(19) United States
(12) Patent Application Publication
(10) Pub. No.: US 2023/0381985 A1
(43) Pub. Date: Nov. 30, 2023

(54) Feather-Indented Knives and Methods of Production

(71) Applicant: Max Albert, Atlanta, GA (US)

(72) Inventor: Max Albert, Atlanta, GA (US)

(21) Appl. No.: 17/826,386

(22) Filed: May 27, 2022

(51) Int. Cl. B26B 9/02; B26B 3/00; B24B 3/54; C21D 9/18

(52) U.S. Cl. CPC B26B 9/02; B26B 3/00; B24B 3/54; C21D 9/18

(57) ABSTRACT

Feather-indented knives and related methods. A feather-indented knife may be produced by a process that involves flat grinding a blade, creating texture and beveling with computerized numeric control (CNC) grinding, hardening the steel with a quench process heat treatment, and grinding the blade with CNC to produce a desired bevel thinness. The knife includes a plurality of lower and upper feather indentations that converge at a middle of the blade and point toward the handle of the knife. The feather indentations have a variable diameter depending on their position along the blade, and they enable sufficient air to enter the space between the blade and the food during a downward or rearward stroke of the knife to separate the food from the blade while cutting.

### FIELD

The disclosure relates to improved knives for cutting food and other materials, and in particular, foods and materials with a relatively higher moisture content such as fruits, vegetables, and raw meats, seafood, and poultry.

### BACKGROUND

Many individuals, such as chefs and cooks, utilize existing knives to cut foods that are relatively high in moisture content. As an existing knife cuts into the food, a vacuum may form between the blade and the food, causing the cut piece of food to adhere to the side of the blade. The adhered piece of food then needs to be dislodged from the blade and placed aside for continued cutting and use of the piece of food in a recipe or meal preparation. The adhered food also increases frequency of the individual interacting with the blade using their fingers, which increases the risk of injury, and it also slows the cutting process and results in time lost during cooking activities.

Accordingly, there is a need for improved knives that significantly reduce or eliminate the problem of food adhering to blades when cutting the food for improved safety and efficiency when cutting food. The present invention addresses this unmet need.

### SUMMARY

In one aspect, the disclosure provides a feather-indented knife, comprising a blade attached to a handle, wherein the blade comprises: a plurality of upper feather indentations along each of a left side and a right side of the blade, and a plurality of lower feather indentations along each of the left side and the right side of the blade. The upper feather indentations and the lower feather indentations converge with each other along a convergence line. The convergence line may positioned between a spine of the blade and an edge of the blade, e.g., about halfway between the spine and the edge, and may run from a forward spine of the blade to a heel of the blade. During a stroke of the blade through a material, such as a food, portions of the material generally may contact outer surfaces of feather indentations to a greater degree than they contact inner surfaces of feather indentations, such that a sufficient amount of air is introduced into or maintained within inner surfaces of feather indentations. The air enables separation of the material from the blade such that the material does not adhere to the blade.

In various embodiments, the width of the plurality of upper feather indentations may be about equal to a width of the plurality of lower feather indentations and diameters of feather indentations may be smaller nearer the convergence line and larger nearer each of an edge of the blade and a spine of the blade. The smaller diameter portions of feather indentations may point toward a heel of the blade and larger diameter portions of feather indentations may point toward either the edge of the blade or the spine of the blade.

A feather-indented knife may be produced by a process that involves flat grinding a blade, creating texture and beveling with computerized numeric control (CNC) grinding, hardening the steel with a quench process heat treatment, and grinding the blade with CNC to produce a desired bevel thinness. The knife includes a plurality of lower and upper feather indentations that converge at a middle of the blade and point toward the handle of the knife. The feather indentations enable increasing amounts of air to enter the space between the blade and the food, during a rearward cutting stroke of the knife, to improve separation of the food from the blade while cutting.

The invention generally relates to feather-indented knives which may be manufactured with appropriate materials and processes and which may be scaled as needed.

Other objects, features, and advantages of the invention will become apparent from the following detailed description taken in conjunction with the accompanying drawings.

### BRIEF DESCRIPTION OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 shows a left side view of an exemplary feather-indented knife, according to the present invention.

FIG. 1A shows an inset of the feather-indented knife.

FIG. 2 shows a right perspective view of an exemplary feather-indented knife.

FIG. 2A shows an inset perspective view of the feather-indented knife.

FIG. 3 shows a profile view of an edge of the exemplary feather-indented knife.

FIG. 3A shows an inset of the edge of the feather-indented knife.

FIG. 4 shows a right-side view of an exemplary feather-indented knife.

FIG. 4A shows an inset of the feather-indented knife.

FIG. 5 shows a left-side perspective view of an exemplary feather-indented knife.

FIG. 6 shows a flowchart of a method of producing a feather-indented knife.

### DETAILED DESCRIPTION OF THE INVENTION

Reference is made herein to the attached drawings. Like reference numerals may be used in the drawings to indicate like or similar elements of the description. The figures are intended for representative purposes and should not be considered limiting.

The present disclosure can be understood more readily by reference to the following detailed description of the present disclosure and the examples included therein.

Before the present articles, systems, devices, and/or methods are disclosed and described, it is to be understood that they are not limited to specific implementations unless otherwise specified, or to particular approaches unless otherwise specified, as such can, of course, vary. It is also to be understood that the terminology used herein is for the purpose of describing aspects only and is not intended to be limiting. Although any methods and materials similar or equivalent to those described herein can be used in the practice or testing of the present disclosure, example methods and materials are now described.

All publications mentioned herein are incorporated herein by reference to disclose and describe the methods and/or materials in connection with which the publications are cited.

### Definitions

It is to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this present disclosure belongs. In this specification and in the claims which follow, reference will be made to a number of terms which shall be defined herein.

As used in the specification and the appended claims, the singular forms “a,” “an,” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the present disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the present disclosure. Thus, if there are a variety of additional steps that can be performed it is understood that each of these additional steps can be performed with any specific aspect or combination of aspects of the methods of the present disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### Feather-Indented Knives

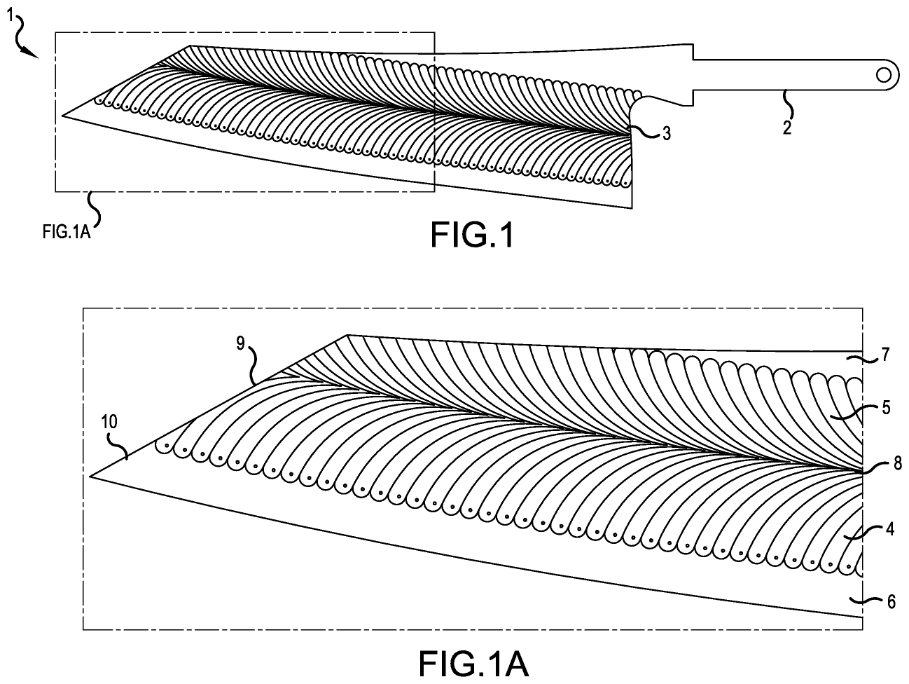

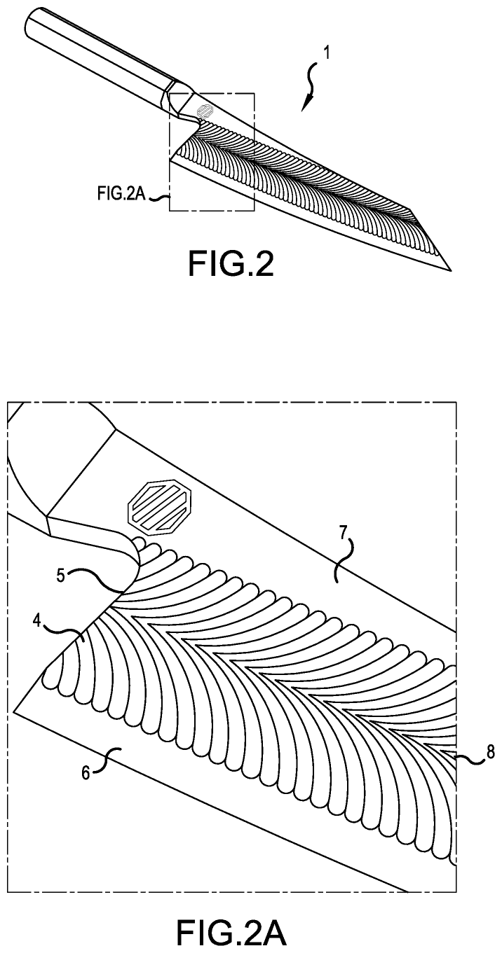

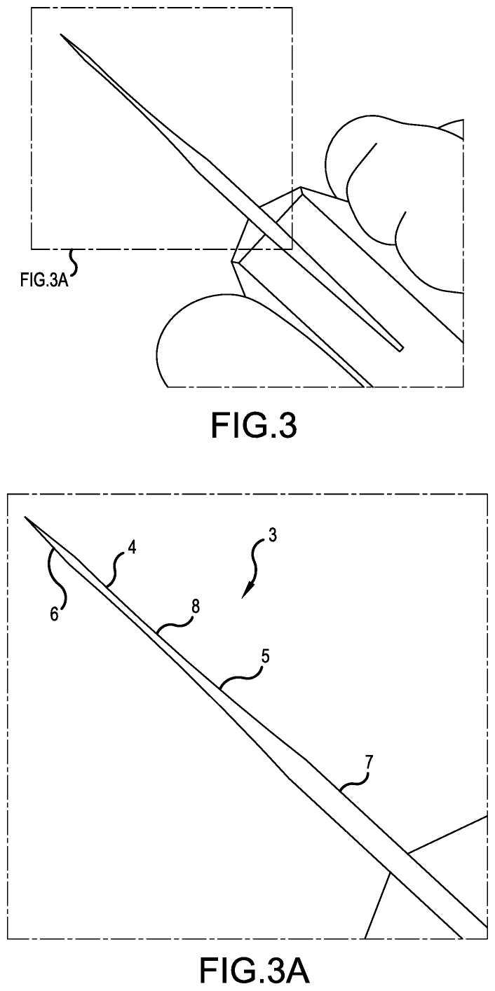

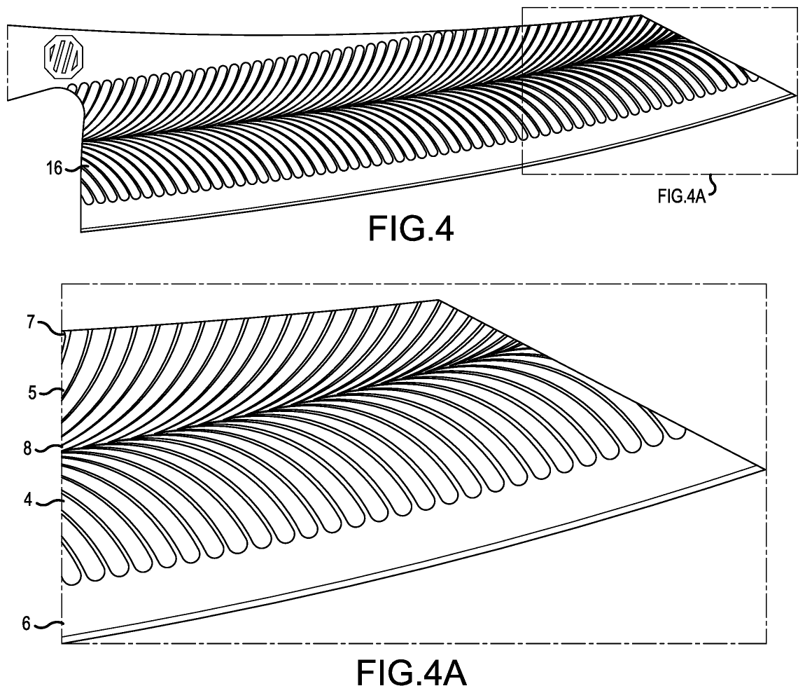

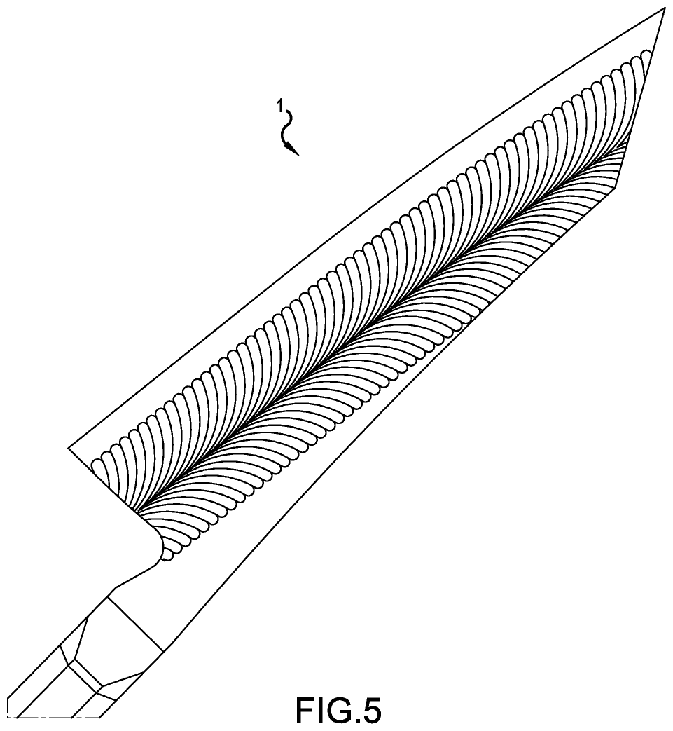

Referring now to FIGS. 1, 1A, 2, 2A, 3, 3A, 4, 4A, and 5, there are shown a left side view (FIG. 1) and an inset (FIG. 1A) of an exemplary feather-indented knife, a right perspective view (FIG. 2) and an inset perspective view (FIG. 2A) of an exemplary feather-indented knife, a profile view of an edge of the exemplary feather-indented knife (FIG. 3) and an inset of the edge of the feather-indented knife (FIG. 3A), a right-side view (FIG. 4) and an inset (FIG. 4A) of an exemplary feather-indented knife, and a left-side perspective view of an exemplary feather-indented knife (FIG. 5). A feather-indented knife 1 is comprised of a handle 2, a blade 3, an edge 6, a top spine 7, a forward spine 9, a tip 10, and a heel 16. The feather-indented knife 1 includes a blade 3 attached to a handle 2. The blade 3 comprises a plurality of upper feather indentations 5 along each of a left side and a right side of the blade 3; and a plurality of lower feather indentations 4 along each of the left side and the right side of the blade 3. The upper feather indentations 5 and the lower feather indentations 4 converge with each other along a convergence line 8. The knife 1 is effective for cutting food and other materials with a higher moisture content because the feather indentations (4, 5) introduce or maintain a sufficient amount of air between portions of the blade and the food, which improves separation of the food from the blade during and after cutting.

In the shown embodiment, the convergence line 8 is positioned between a spine 7 of the blade 3 and an edge 6 of the blade 3 and is positioned about halfway between the spine 7 and the edge 6. The convergence line 8 also runs from a forward spine 9 of the blade 3 to a heel 16 of the blade 3. As a result, the feather indentations (4, 5) cover a wider surface area of the blade and in this manner, the air is more effectively introduced or maintained between the blade and the food, regardless of what portion of the blade is used for a particular stroke of the knife.

In the shown embodiment, a width of the plurality of upper feather indentations 5 along each of the left side and the right side of the blade 3 is about equal to a width of the plurality of lower feather indentations 4 along each of the left side and the right side of the blade 3, and diameters of feather indentations (4, 5) are smaller nearer the convergence line 8 and are larger nearer each of an edge 6 of the blade 3 and a spine 7 of the blade 3. In addition, in the shown embodiment, smaller diameter portions of feather indentations (4, 5) point toward a heel 16 of the blade 3 and larger diameter portions of feather indentations (4, 5) point toward either the edge 6 of the blade 3 or the spine 7 of the blade 3. The smaller diameter portions may more effectively penetrate a space between the blade 3 and the food for introduction or maintenance of air pockets between the blade 3 and the food, and as the blade 3 moves through the food, the larger diameter portions contact the food and increase the amount of air in the air pockets. As a result, the food is more readily separated from the blade 3.

In the shown embodiment, during a stroke of the blade 3 through a material (e.g., a down stroke, a rearward stroke, a forward stroke, an upward stroke), portions of the material contact outer surfaces (i.e., peaks) of feather indentations (4, 5) to a greater degree than they contact inner surfaces (i.e., valleys or grooves) of feather indentations (4, 5), which instead contact air to form air pockets. During the stroke of the blade 3 through the material, a sufficient amount of air is introduced into or maintained within inner surfaces of feather indentations, which enables separation of the material from the blade 3 such that the material does not adhere to the blade 3. In addition, as shown at FIG. 3 and FIG. 3A, a thickness of the blade is greater at or near the feather indentations (4, 5) and is lesser at or near the convergence line 8. This helps introduce and maintain air pockets between the material and the blade during cutting. In this manner, the material does not adhere to the blade 3.

### Methods of Manufacture

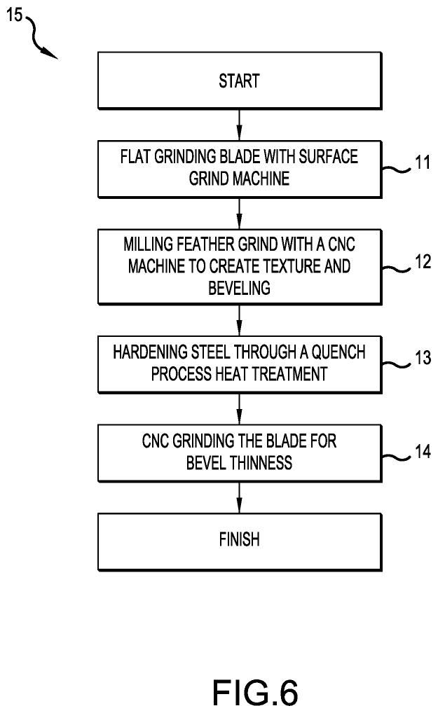

Referring now to FIG. 6, there is shown a flowchart of a method of producing a feather-indented knife with a feather grind process. A feather-indented knife may be produced by a feather grind process 15, the feather grind process comprising creating a steel knife that comprises a blade attached to a handle, flat grinding 11 the blade with a surface grind machine, feather grinding 12 the blade with a CNC machine to create texture and beveling, hardening 13 the blade through a quench process heat treatment, and grinding 14 the blade with the CNC machine to produce a bevel thinness and generate a finished blade and a finished knife. The finished knife may include all or a subset of the characteristics disclosed herein for a feather-indented knife and may include a feather design on the blade thereof. In various embodiments, the finished knife includes a feather milling grind and also has a full compound ground symmetric along both sides of the bevel. There is also a complete air pocket throughout the bevel which aids in food release.

Feather-indented knife parameters

| Parameter | Value |
|---|---|
| Thickness of steel: | 0.098″ or 2.5 mm |
| Angle of double bevel blade | 7 Degrees Inclusive |
| which is ground: | |
| Height of edge band from edge | 0.275″ or 7 mm |
| to the milling: | |
| Radius angle of feather grind/ | Each groove in the feather pattern is cut |
| depth: | with a .1875″ ball end mill for a radius |
| | of .09375″. The depth of the grooves |
| | per side tapers from about .012″ or 0.3 |
| | mm near the spine to 0.044″ or 1.12 |
| | mm near the edge. |
| Width of the thinnest part of | 0.25 mm or 0.01″ |
| the feather grind: | |

Feather-indented knife production process

| Step | |
|---|---|
| number | Description |
| 1 | The steel is flat ground to 2.5 mm with a surface grind machine. |
| 2 | The feather grind is milled by a CNC machine to create the |
| | texture and beveling. |
| 3 | The steel is hardened through a quench process heat treatment. |
| 4 | The blades are then CNC ground for bevel thinness. |

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

The following is claimed:

1. A feather-indented knife, comprising:
a blade attached to a handle;
wherein the blade comprises:
a plurality of upper feather indentations along each of a left side and a right side of the blade; and
a plurality of lower feather indentations along each of the left side and the right side of the blade;
wherein the upper feather indentations and the lower feather indentations converge with each other along a convergence line.

2. The feather-indented knife of claim 1, wherein the convergence line is positioned between a spine of the blade and an edge of the blade.

3. The feather-indented knife of claim 2, wherein the convergence line is positioned about halfway between the spine and the edge.

4. The feather-indented knife of claim 3, wherein the convergence line runs from a forward spine of the blade to a heel of the blade.

5. The feather-indented knife of claim 1, wherein a width of the plurality of upper feather indentations along each of the left side and the right side of the blade is about equal to a width of the plurality of lower feather indentations along each of the left side and the right side of the blade.

6. The feather-indented knife of claim 5, wherein diameters of feather indentations are smaller nearer the convergence line and are larger nearer each of an edge of the blade and a spine of the blade.

7. The feather-indented knife of claim 6, wherein smaller diameter portions of feather indentations point toward a heel of the blade and larger diameter portions of feather indentations point toward either the edge of the blade or the spine of the blade.

8. The feather-indented knife of claim 1, wherein during a stroke of the blade through a material, portions of the material contact outer surfaces of feather indentations to a greater degree than they contact inner surfaces of feather indentations.

9. The feather-indented knife of claim 8, wherein during the stroke of the blade through the material, a sufficient amount of air is introduced into or maintained within inner surfaces of feather indentations.

10. The feather-indented knife of claim 9, wherein the sufficient amount of air enables separation of the material from the blade and the material does not adhere to the blade.

11. A feather-indented knife produced by a process, the process comprising:
creating a steel knife that comprises a blade attached to a handle;
flat grinding the blade with a surface grind machine;
feather grinding the blade with a CNC machine to create texture and beveling;
hardening the blade through a quench process heat treatment; and
grinding the blade with the CNC machine to produce a bevel thinness and generate a finished blade;
wherein the finished blade comprises:
a plurality of upper feather indentations along each of a left side and a right side of the blade; and
a plurality of lower feather indentations along each of the left side and the right side of the blade;
wherein the upper feather indentations and the lower feather indentations converge with each other along a convergence line.

12. The feather-indented knife of claim 11, wherein the convergence line is positioned between a spine of the blade and an edge of the blade.

13. The feather-indented knife of claim 12, wherein the convergence line is positioned approximately halfway between the spine and the edge.

14. The feather-indented knife of claim 13, wherein the convergence line runs from a forward spine of the blade to a heel of the blade.

15. The feather-indented knife of claim 11, wherein a width of the plurality of upper feather indentations along each of the left side and the right side of the blade is about equal to a width of the plurality of lower feather indentations along each of the left side and the right side of the blade.

16. The feather-indented knife of claim 15, wherein diameters of feather indentations are smaller nearer the convergence line and are larger nearer each of an edge of the blade and a spine of the blade.

17. The feather-indented knife of claim 16, wherein smaller diameter portions of feather indentations point toward a heel of the blade and larger diameter portions of feather indentations point toward either the edge of the blade or the spine of the blade.

18. The feather-indented knife of claim 11, wherein during a stroke of the blade through a material, portions of the material contact outer surfaces of feather indentations to a greater degree than they contact inner surfaces of feather indentations.

19. The feather-indented knife of claim 18, wherein during the stroke of the blade through the material, a sufficient amount of air is introduced into or maintained within inner surfaces of feather indentations.

20. The feather-indented knife of claim 19, wherein the sufficient amount of air enables separation of the material from the blade and the material does not adhere to the blade.
